(19) United States
(12) Patent Application Publication
(10) Pub. No.: US 2007/0133659 A1
(43) Pub. Date: Jun. 14, 2007

(54) MIMO-CDMA apparatus and the coding/decoding method thereof

(76) Inventors: Juinn-Horng Deng, Longtan Township (TW); Jeng-Kuang Hwang, Jhongli City (TW); Po-Tien Lee, Rende Township (TW); Fu-Chin Shau, Shetou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/546,332

(22) Filed: Oct. 12, 2006

(30) Foreign Application Priority Data
Dec. 9, 2005 (TW) 094143537

(51) Int. Cl. H04B 1/00; H04L 1/02

(52) U.S. Cl. 375/144; 375/267

(57) ABSTRACT

A Multiple-Output Multiple-Input Code-Division Multiple Access (MIMO-CDMA) apparatus and the coding method thereof. The apparatus includes a transmitter side and receiver side. Both of the transmitter side and the receiver side have a plurality of antennas for achieving the effect of multi-path transmission and receiving. In addition, at the receiver side, use preamble-spreading codes and space-time block coding technology to eliminate multi-path signal interference as well as to modify carrier frequency shift of the received signal.

### FIELD OF THE INVENTION

The present invention relates generally to a multiple-access digital modulation apparatus, and particularly to a Multiple-Output Multiple-Input Code-Division Multiple Access (MIMO-CDMA) apparatus and the coding/decoding method thereof.

### BACKGROUND OF THE INVENTION

With the arrival of next-generation mobile communication apparatus, in order to satisfy the demand of wireless wideband and high-speed data transmission, how to use limited resources has become an important development direction of wireless communication technologies. Multiple-Input Multiple-Output (MIMO) is a communication technology using multiple antennas at both the transmitter side and the receiver side, which can dramatically increase the communication quality. Space-time block coding (STBC) can be built on the MIMO communication system. STBC is an excellent coding for transmitting diversion blocks, and is usually applied in a Multiple-Output Multiple-Input Orthogonal Frequency-Division Modulation (MIMO-OFDM) communication system with the MIMO technology.

At present, the MIMO-OFDM communication system is an important technology for resisting selective frequency fading caused by multi-path effects in outdoors.

However, because MIMO-OFDM transmits by synthesizing multiple subcarriers, the peak-to-average power ratio (PAPR) and the dynamic ranges thereof goes too large. In such a circumstance, radio-frequency (RF) power amplifiers, digital-to-analog converters (DACs), and analog-to-digital converters (ADCs) need substantial linear operating ranges to prevent signals from distortion, which makes the RF circuit design more complicated.

### SUMMARY

The purpose of the present invention is to provide a MIMO-CDMA apparatus. By using the feature of single-carrier transmission in CDMA, the PAPR of output signals can be reduced, signal distortion phenomenon of RF circuits in communication systems can be improved, and RF circuit complexity can be decreased.

Another purpose of the present invention is to provide a MIMO-CDMA apparatus. By adopting multiple antenna for receiving and by using the feature of low space correlation at receiver side, serious signal distortions due to single-channel fading can be avoided.

Another purpose of the present invention is to provide a MIMO-CDMA apparatus. By using preamble-spreading codes and space-time block coding technologies, multi-path and frequency-offset problems can be conquered.

Still another purpose of the present invention is to provide a MIMO-CDMA apparatus which performs channel estimation, packet timing estimation and frequency shift estimation, phase estimation, and data despreading on received signals using preamble-spreading codes, pilot-spreading codes, and data-spreading codes.

The present invention provides a MIMO-CDMA apparatus. The transmitter side thereof includes a coding unit, a modulation unit, a diversion-coding unit, a spreading unit, a plurality of RF transmitting modules, and a plurality of transmitting antennas. The receiver side thereof includes a plurality of receiving antennas, a plurality of estimation units, a despreading unit, a diversion-decoding unit, a demodulation unit, and a decoding unit.

At the transmitter side of the MIMO-CDMA apparatus provided according to the present invention, the coding unit described above is used to code data. The modulation unit couples to the coding unit, and is used to modulate the output of the coding unit. The diversion-coding unit couples to the modulation unit, and is used to code the output signals of the modulation unit as well as to output a plurality of block data. The spreading unit couples to the diversion-coding unit, and, by using the data-spreading code, the pilot-spreading code, and the preamble-spreading code, performs spreading coding and then outputs a plurality of spreading data. The plurality of RF transmitting modules couples, respectively, between the spreading unit and the plurality of transmitting antennas, and transmits spreading data using corresponding transmitting antennas.

At the receiver side of the MIMO-CDMA apparatus provided according to the present invention, the plurality of receiving antennas described above is used to the signals transmitted by the transmitting antennas described above. The signals are transmitted to the receiving antennas via multiple paths. The plurality of estimation units couples to the receiving antennas, respectively, and performs channel estimation, packet timing estimation, and frequency offset estimation to the signals received by the receiving antennas using the preamble-spreading code, and performs phase estimation to the signals received by the receiving antennas using the pilot-spreading code. The despreading unit couples to the estimation units, and, by using the data-spreading code, performs data despreading to the signals output by the estimation units and outputs despreading data. The diversion-decoding unit couples to the despreading unit, and performs diversion decoding to the despreading data. Next, the demodulation unit couples to the diversion-decoding unit, and demodulates the signals output by the diversion-decoding unit. The decoding unit couples to the demodulation unit, and decodes the signals output by the demodulation unit. Here, the signals received by the receiving antennas correspond to the spreading signals transmitted by the transmitting antennas, and the estimation units and the receiving antennas have a one-to-one correspondence.

According to the embodiments of the present invention, the methods of modulating the output of the coding unit by the modulation unit include Quadrature Phase-Shift Keying (QPSK). In addition, the methods of modulating the output of the modulation unit by the diversion-coding unit include space-time block coding algorithm.

According to the embodiments of the present invention, the spreading unit includes a plurality of multiplexers coupled to the RF transmitting modules, respectively, and a plurality of data-spreading units coupled between one of the multiplexers and the diversion-coding unit and performing spreading coding to every block datum by using the data-spreading code and the pilot-spreading code. A preamble-spreading unit couples to the multiplexers, and transmits the preamble-spreading code to the multiplexers. Each multiplexer corresponds to a preamble-spreading code. The multiplexers output the spreading data, respectively, according to outputs of a data pilot-spreading unit and the corresponding preamble-spreading code. The data-spreading code and the pilot-spreading code are orthogonal, and any two preamble-spreading codes are orthogonal as well.

According to the embodiments of the present invention, each estimation unit described above includes a RF receiving module, a cyclic-prefix removal unit, a time-synchronization and frequency-shift estimation unit, a channel estimation unit, and a phase estimation unit. The RF receiving module couples to the corresponding receiving antenna, and outputs a received signal by using the signals received by the receiving antenna. The time-synchronization and frequency-shift estimation unit couples to the RF receiving module, and outputs a packet timing and frequency-shift data of the received signal. The cyclic-prefix removal unit couples between the despreading unit and the RF receiving module, and removes a cyclic prefix from the received signals according to the packet timing data. The channel estimation unit couples between the RF receiving module and the despreading unit, and estimates the channel effects of the received signal according to the preamble-spreading code and outputs a channel-estimation value to the despreading unit. The phase estimation unit couples between the despreading unit and the cyclic-prefix removal unit, and outputs phase-shift data to the despreading unit according to the pilot-spreading code. The despreading unit performs data despreading to the output of the cyclic-prefix removal unit according to the data-spreading code, the phase-shift data, and the channel-estimation value.

From one aspect of the present invention, the present invention provides a coding method for MIMO-CDMA apparatuses. The coding method is suitable for MIMO-CDMA apparatuses, which includes a plurality of transmitting antennas and a plurality of receiving antennas. The coding method includes the following steps. First, perform diversion coding to a modulation datum, and output a plurality of block data. Then, spread the block data describe above by using the data-spreading code, the pilot-spreading code, and a plurality of preamble-spreading codes, and output spreading data. Finally, by a plurality of transmitting antennas, transmit the spreading data, wherein the spreading data and the transmitting antennas have a one-to-one correspondence.

From another aspect of the present invention, the present invention provides a decoding method for MIMO-CDMA apparatuses, which include a plurality of receiving antennas. The decoding method includes the following steps. First, by using a plurality of preamble-spreading codes, perform packet timing estimation, frequency shift estimation, and channel estimation, and output corresponding the i-th packet timing and frequency-shift data and the i-th channel-estimation value, where i is a natural number and the maximum value thereof is the number of the receiving antennas. Then, according to the i-th packet timing, remove the cyclic prefix of the received signal of the i-th receiving antenna. Next, by using the pilot spreading-code, perform phase estimation to the received signal of the i-th receiving antenna after removal of the cyclic prefix thereof. Afterwards, by using the data-spreading code, the i-th phase-shift data, the i-th channel-estimation value, perform data-spreading to the received signal of the i-th receiving antenna after removal of the cyclic prefix thereof, and produce the i-th sub-despreading data. Then, according to all of the sub-despreading data, output a despreading datum, and perform diversion decoding to the despreading datum.

The present invention combines the concepts of MIMO and CDMA to make MIMO apparatuses have the high gain of multi-path transmission and avoid the problems of communication quality due to fading of specific frequencies or channel fading. Meanwhile, by using preamble-spreading codes and STBC technologies, the multi-path effect and the frequency-shift problem can be conquered.

In order to make the structure and characteristics as well as the effectiveness of the present invention to be further understood and recognized, the detailed description of the present invention is provided as follows along with preferred embodiments and accompanying figures.

### BRIEF DESCRIPTION OF THE DRAWINGS

FIG. 1 is a block diagram of the transmitter side of a 2*2MIMO-CDMA apparatus according to an embodiment of the present invention;

FIG. 2 is a block diagram of the estimation unit of the receiver side of a 2*2MIMO-CDMA apparatus according to an embodiment of the present invention;

FIG. 3 is a block diagram of the receiver side of a 2*2MIMO-CDMA apparatus according to an embodiment of the present invention;

FIG. 4 is a coding method of a MIMO-CDMA apparatus according to an embodiment of the present invention; and

FIG. 5 is a decoding method of a MIMO-CDMA apparatus according to an embodiment of the present invention.

### DETAILED DESCRIPTION

A MIMO-CDMA apparatus has a transmitter side and a receiver side. The transmitter side is a combination of the MIMO-CDMA apparatus and a plurality of transmitting antennas; the receiver side is a combination of the MIMO-CDMA apparatus and a plurality of receiving antennas. In order to make the person skilled in the art understand the schemes of the present invention more clearly, in the following, a 2-input 2-output CDMA apparatus (abbreviated as 2*2MIMO-CDMA apparatus thereinafter) is used as an example.

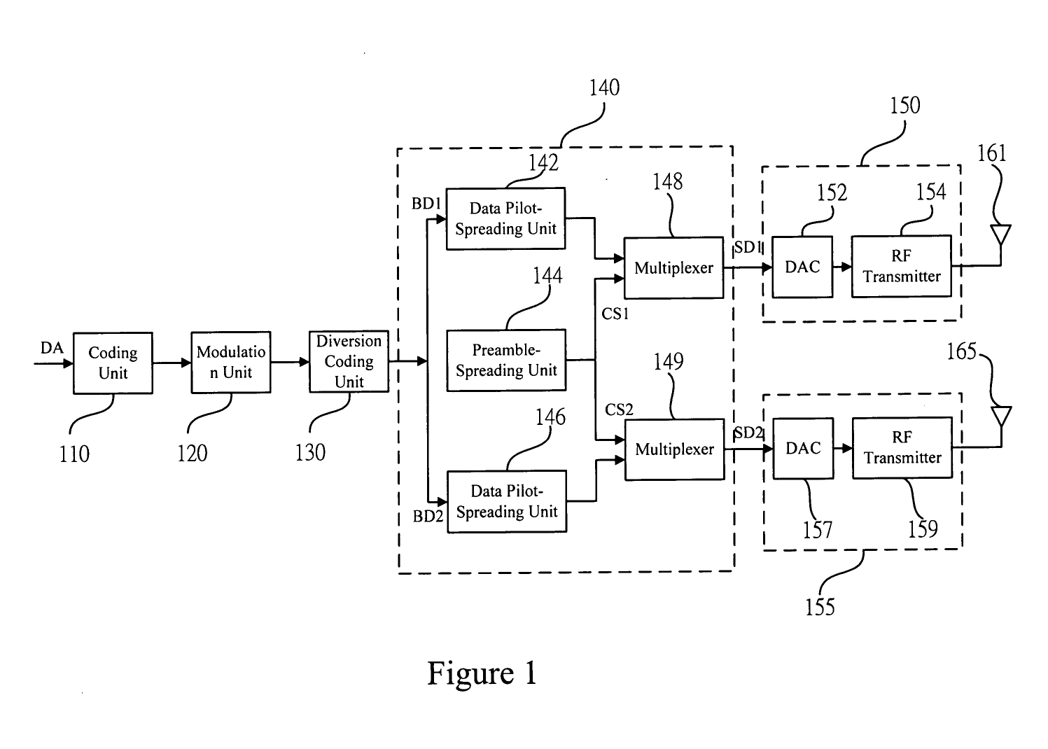

First, the transmitter side of the 2*2MIMO-CDMA apparatus will be described. FIG. 1 is a block diagram of the transmitter side of a 2*2MIMO-CDMA apparatus according to an embodiment of the present invention. In the present embodiment, the transmitter side of the 2-input 2-output CDMA apparatus will be abbreviated as the transmitter side of the 2*2MIMO-CDMA thereinafter. The transmitter side of the 2*2MIMO-CDMA includes a coding unit 110, a modulation unit 120, a diversion-coding unit 130, a spreading unit 140, RF transmitting modules 150, 155, and transmitting antennas 161, 165.

The modulation unit 120 couples between the diversion-coding unit 130 and the coding unit 110. The spreading unit 140 couples between the diversion-coding unit 130 and the RF transmitting modules 150, 155, wherein the spreading unit 140 further includes data pilot-spreading units 142, 146, a preamble-spreading unit 144, and multiplexers 148, 149. The RF transmitting modules 150, 155 include, respectively, DACs 152, 157 and RF transmitters 154, 159. The outputs of the diversion-coding unit 130 couple to the data pilot-spreading units 142, 146, respectively; the data pilot-spreading units 142, 146 couple to the multiplexers 148, 149, respectively. In addition, the preamble-spreading unit 144 couples to the multiplexers 148, 149, respectively. The DACs 152, 157 couple between the RF transmitters 154, 159 and the multiplexers 148, 149, respectively. The transmitting antennas 161, 165 couple to the RF transmitters 154, 159.

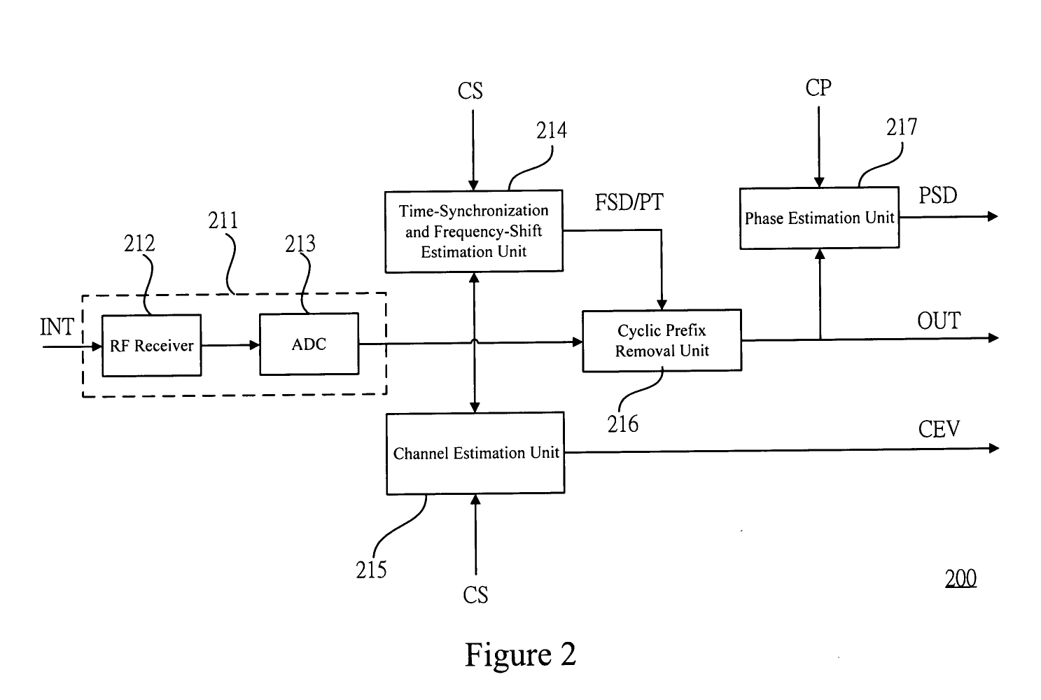

FIG. 2 is a block diagram of the estimation unit of the receiver side of a 2*2MIMO-CDMA apparatus according to an embodiment of the present invention. As shown in the figure, the estimation unit 200 includes a RF receiving module 211, a time-synchronization and frequency-shift estimation unit 214, a channel estimation unit 215, a cyclic-prefix removal unit 216, and a phase estimation unit 217, wherein the RF receiving module 211 further includes a RF receiver 212 and an ADC 213. The RF receiver 212 couples to the ADC 213. The outputs of the ADC 213 couple to the time-synchronization and frequency-shift estimation unit 214, the channel estimation unit 215, and the cyclic-prefix removal unit 216, respectively. The output of the cyclic-prefix removal unit 216 couples to the phase estimation unit 217. After performing channel estimation, phase estimation, packet timing estimation and frequency-shift estimation, and removing cyclic prefix to the input signal INT in terms of the estimation unit 200, a channel-estimation value (CEV), a phase-shift data (PSD), and an output signal (OUT) are output, respectively.

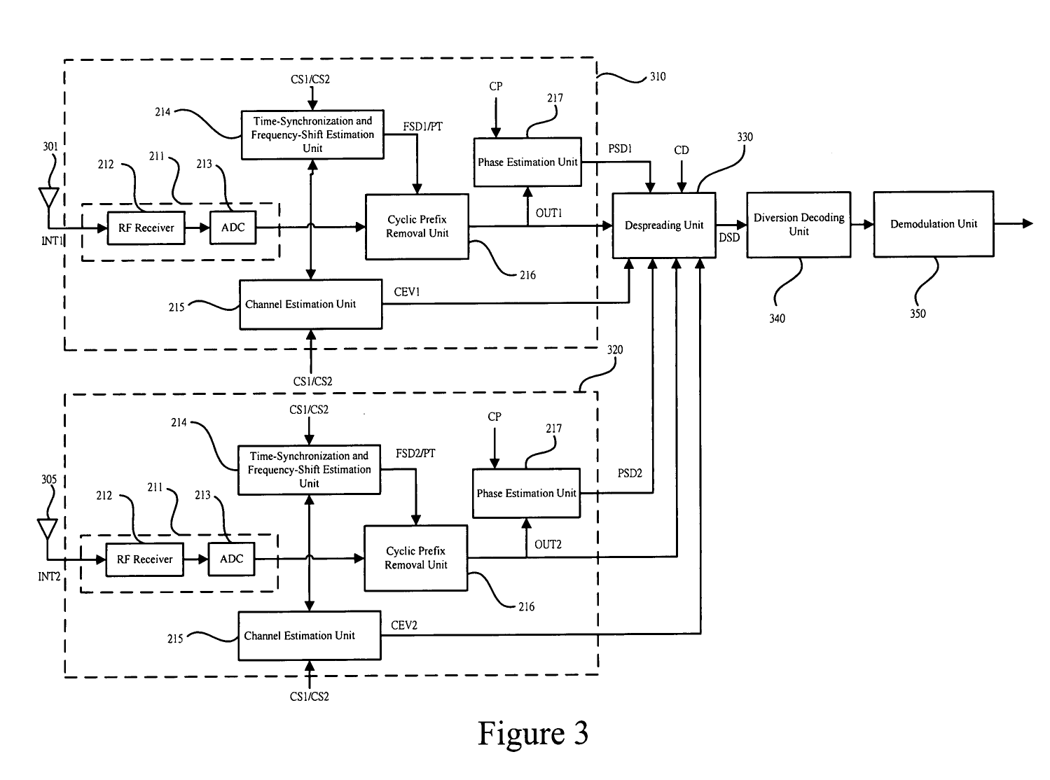

FIG. 3 is a block diagram of the receiver side of a 2*2MIMO-CDMA apparatus according to an embodiment of the present invention. Thereinafter, the receiver side of the 2-input 2-output CDMA apparatus will be abbreviated as the receiver side of the 2*2MIMO-CDMA. The receiver side of the 2*2MIMO-CDMA includes two receiving antennas 301, 305, two estimation units 310, 320, a despreading unit 330, a diversion-decoding unit 340, and a demodulation unit 350. The circuit composition units of the estimation units 310, 320 are the identical. The connection of the internal circuits thereof is shown as the estimation unit 200 in FIG. 2 according to the present embodiment, and will not be described again here. The RF receiver 212 in the estimation units 310, 312 couples to the receiving antennas 301, 305, respectively. The outputs of the estimation units 310, 320 couple to the despreading unit 330, respectively; while the diversion-coding unit 340 couples between the despreading unit 330 and the demodulation unit 350.

After describing the electrical connections of the transmitter and the receiver sides of the 2*2MIMO-CDMA apparatus according to the embodiment of the present invention, in the following, the operation method of the transmitter and the receiver sides of the 2*2MIMO-CDMA will be further described. First, the circuit operation method of transmitter side of the 2*2MIMO-CDMA will be described with reference to FIG. 1.

The coding unit 110 receives a datum DA. After coding, the result is output to the modulation unit 120. The modulation unit 120 modulates the coded datum DA. In the present embodiment, the modulation method includes QPSK. The diversion-coding unit 130 performs diversion coding to the output of the modulation unit 120 by using diversion-coding technology (such as STBC). After performing diversion coding, two block data BD1, BD 2 will be output. The number of the block data BD1, BD2 is the same as the number of the receiving antennas. In the present embodiment, the number is two. In another embodiment, the diversion-coding technology used by the diversion-coding unit 130 also includes spatial demultiplexing (DeMUX) algorithm.

The block data BD1, BD2 are transmitted, respectively, to the data pilot-spreading units 142, 146; the data pilot-spreading units 142, 146 perform data-spreading coding and pilot-spreading coding to the block data BD1, BD2 by using the data-spreading code CD and the pilot-spreading code, respectively. The data-spreading code CD can be expressed mathematically as:
CD=[c_{d}(0)c_{d}(1) . . . c_{d}(N−1)]^{T}
The bit length of the data-spreading code CD is N, where N is a natural number. c_{d}(0) . . . c_{d}(N−1) are digital logic signals (for example, logic 1 or logic 0), respectively. The data-spreading code CD is common to the block data BD1, BD2. In another embodiment, CD is common to all block codes output by the diversion-coding unit.

The pilot-spreading code CP is also common to the block data BD1, BD2.

It can be expressed mathematically as:
CP=[cₚ(0)cₚ(1) . . . cₚ(N−1)]^{T}
The bit length of the pilot-spreading code CP is identical to the bit length of the data-spreading code CD, which is N. cₚ(0) . . . cₚ(N−1) are digital logic signals (for example, logic 1 or logic 0), respectively. Moreover, the pilot-spreading code CP maintains orthogonality with the data-spreading code CD, namely, CP^{T}·CD=0.

The preamble-spreading code CS provided by the preamble-spreading unit 144 includes two codes: the first preamble-spreading code CS1 and the preamble-spreading code CS2, and they are output to the multiplexers 148, 149, respectively. The two codes correspond to the block data BD1, BD2 output by the diversion-coding unit 130, respectively. The mathematical expression of the preamble-spreading code CS is:
CS=[c_{s,i}(0)c_{s,i}(1) . . . c_{s,i}(N−1)]^{T}, for i=1, 2
The bit length of each preamble-spreading code CSi (i=1, 2) is N, where N is a natural number. c_{s,i}(0) . . . c_{s,i}(N−1) are digital logic signals (for example, logic 1 or logic 0), respectively. When i=1, the first preamble-spreading code CS1 corresponds to the block data BD1, and outputs to the multiplexer 148; when i=2, the second preamble-spreading code CS2 corresponds to the block data BD2, and outputs to the multiplexer 149, wherein i represents the i-th antenna, and the preamble-spreading codes CS1, CS2 of the two antenna are orthogonal to each other, namely, CS1.CS2=0.

When the block data BD1, BD2 are input to the data pilot-spreading units 142, 146, the data pilot-spreading units 142, 146 perform the data operations of data spreading and pilot spreading to the block data BD1, BD2 according to the data-spreading code CD and the pilot-spreading code CP described above.

Then, the coded data are transmitted to the multiplexers 148, 149, respectively.

The multiplexers 148, 149 use the output data of the preamble-spreading code CS and the data pilot-spreading units 142, 146 to output spreading data SD1, SD2, respectively, by a timing-switching method.

The multiplexers 148, 149 output the spreading data SD1, SD2 to the DACs 152, 157, respectively. The DACs 152, 157 convert the spreading data SD1, SD2 in digital data format to analog data format, and output to the RF transmitters 154, 159, respectively. The RF transmitters 154, 159 convert the outputs of the DACs 152, 157 to RF signals, and transmit them via the transmitting antennas 161, 165, respectively.

Next, the circuit operation method of the receiver side of the 2*2MIMO-CDMA will be described. In the following description, please refer to FIG. 2 and FIG. 3 simultaneously. The circuit operation method of the estimation unit 200 will be described first. The RF receiver 212 receives an input signal INT from outside (for example, from an antenna). The input signal is converted to a digital signal in terms of the ADC 213, and is output to the time-synchronization and frequency-shift estimation unit 214, the channel estimation unit 215, and the cyclic-prefix removal unit 216. The time-synchronization and frequency-shift estimation unit 214 estimates frequency-shift data FSD and packet timing PT according to the preamble-spreading code CS.

The estimated frequency-shift data FSD and packet timing PT can be verified by the following method:

First, by taking a frequency-selective channel as the transmission environment for example, the channel can be expressed by using discrete-time pulse response of length L as shown below:
gᵢ=[α_{i,0}α_{i,1} . . . α_{i,L-1}]^{T}, i=1, 2
where i represents the i-th antenna, and the l-th channel α_{i,1} has the fading characteristics of Rayleigh distribution.

By the preamble-spreading code CS described above, the preamble-spreading code CS is comprised by c_{s,i}(0) . . . c_{s,i}(N−1) digital logic signals. If the location of c_{s,i}(k) is the k-th preamble block, where k is a natural number, then the signal of the k-th preamble block can be expressed mathematically as:

$${y}^{( k )} = ( {\sum }_{l = 1}^{L} {α}_{1 , l}^{( k )} {c}_{s , 1 , l} {s}_{1}^{( k )} + {\sum }_{l = 1}^{L} {α}_{2 , l}^{( k )} {c}_{s , 2 , l} {s}_{2}^{( k )} ) diag \{ {z}^{( k )} \} + {n}^{( k )}$$

where z^{(k)} represents the frequency-shift vector of the k-th preamble block
z^{(k)}=[1e^{j2πf}^{₀}^{T}^{_{c}}e^{j2πf}^{ₒ}^{(2T}^{_{c}}⁾ . . . e^{j2πf}^{₀}^{(N-1)T}^{_{c}}]^{T}e^{j2πf}^{₀}^{kNT}^{_{c}}

In the above equation, f₀ represents frequency shift, and T_{c} represents effective pulse zone of spreading codes. Likewise, let channels be located between two consecutive blocks, and then channel responses will be maintained equal. Thereby, the k-th received preamble-block signal can be rewritten as:
y^{(k)}=he^{j2πf}^{₀}^{kNT}^{_{c}}+n^{(k)}
where h represents effective composite signature vector (CSV).

$$h = ( {\sum }_{l = 1}^{L} {α}_{1 , l} {c}_{s , 1 , l} + {α}_{2 , l} {c}_{s , 2 , l} ) diag \{ 1 , {ⅇ}^{j2π {f}_{o} {T}_{c}} , … , {ⅇ}^{j2π {f}_{o} ( N - 1 ) {T}_{c}} \}$$

Then, multiply the k-th received preamble-block signal with (k+1)-th one, and get the statistical signal as follows:

$$q = {y}^{( k ) ″} {y}^{( k + 1 )} = {\sum }_{n = 1}^{N} {\vert {h}_{n} \vert}^{2} {ⅇ}^{j2π {f}_{o} {NT}_{c}} + \tilde{n}$$

By the above equation, frequency-shift estimation value can be given as:

$${\hat{f}}_{o} = \frac{1}{2 π {NT}_{c}} {tan}^{- 1} \{ \frac{Im ( q )}{Re ( q )} \}$$

Next, the estimation packet timing PT can be verified by the following mathematical expression.

When the packet data is arrived, the k-th received data can be expressed as:

$${y}^{( k )} ( n ) = \{ {\sum }_{l = 1}^{L} {α}_{1 , l} {c}_{s , 1 , l} ( n ) + {α}_{2 , l} {c}_{s , 2 , l} ( n ) \} {ⅇ}^{j2π {f}_{o} ( n + kN ) {T}_{c}}$$

Then, by using the matching filter of the preamble-spreading code CS, the matched signal is given as:

$${\tilde{y}}^{( k )} ( n ) = {\sum }_{l = 1}^{L} \{ {\vert {\sum }_{m = 1}^{N} {c}_{s , 1 , l} ( m ) {y}^{( k )} ( n + m ) \vert}^{2} + {\vert {\sum }_{m = 1}^{N} {c}_{s , 2 , l} ( m ) {y}^{( k )} ( n + m ) \vert}^{2} \}$$

At this time, in order to perform packet detection, a threshold will be provided for comparison. In the present embodiment, a moving average method will be used to get the adaption starting point. Thereby, the starting point will be adjusted automatically to help detect the packet timing PT robustly. The mathematical expression is:

$${t}^{( k )} ( n ) = {\sum }_{m = 1}^{N} {\vert {y}^{( k )} ( n + m ) \vert}^{2}$$

Because the transmitted preamble-spreading code CS has gains, thereby when the packet arrives, the matching-processed signals will be greater than the average-processed staring point. At this time, the packet timing PT will be detected as:

$$\hat{n} = {arg}_{n} \{ {\tilde{y}}^{( k )} ( n ) > {t}^{( k )} ( n ) * α \}$$

where α is the starting-point adjusting factor.

After performing estimations of the frequency-shift data FSD and the packet timing PT, by using the estimation values of the frequency-shift data FSD and the packet timing PT, the cyclic-prefix removal unit 216 performs frequency compensation and timing positioning of the input signal INT, performs removal of the cyclic prefix, and produces an output signal OUT. However, after frequency compensation, residual frequency shift remains, which will cause phase shift of the received data INT and then will further affect demodulation to the input signal by the demodulation unit 350. To overcome the problem, the pilot-spreading code CP will be used to perform phase compensation.

Afterwards, the phase estimation unit 217 performs phase-shift estimation to the input signal INT according to the pilot-spreading code CP and the output signal OUT of the cyclic-prefix removal unit 216. First, it is known that after frequency-shift compensation, the k-th receiving pilot block with remaining frequency shift, which is the block where the cₚ(k) in cₚ(0) . . . cₚ(N−1) locates, k being a natural number, can be expressed with the following mathematical model:

$${x}^{( k )} = \{ {\sum }_{l = 1}^{L} {α}_{1 , l}^{( k )} ( {c}_{d , l} {d}_{1}^{( k )} + {c}_{p , l} {p}_{1}^{( k )} ) + {\sum }_{l = 1}^{L} {α}_{2 , l}^{( k )} ( {c}_{d , l} {d}_{2}^{( k )} + {c}_{p , l} {p}_{2}^{( k )} ) \} • diag \{ {z}^{( k )} \} + {n}^{( k )}$$

where c_{p,i} represents the temporal signature vector of the pilot-spreading code CP after the (l−1)-th delay as shown below:

$$\begin{matrix}{c}_{p , 1} = {[ {c}_{p} ( 0 ) {c}_{p} ( 1 ) ⋯ {c}_{p} ( N - 1 ) ]}^{T} \\ {c}_{p , 2} = {[ {c}_{p} ( N - 1 ) {c}_{p} ( 0 ) ⋯ {c}_{p} ( N - 2 ) ]}^{T} \\ ⋮ \\ {c}_{p , l} = {[ {c}_{p} ( N - ( l - 1 ) ) ⋯ {c}_{p} ( N - 1 ) {c}_{p} ( 0 ) ⋯ {c}_{p} ( N - l ) ]}^{T}\end{matrix}$$

In addition, the (l−1)-th delayed pilot-spreading code CP and the data-spreading code still maintain orthogonality, namely, c^{T}_{p,l}c_{d,l}=0. Besides, likewise, for simplicity, we set the k-th pilot symbol transmitted by the i-th antenna is equal to one (pᵢ^{(k)}=1). Let z^{(k)} represents the frequency-shift vector of the k-th preamble block as follows:
z^{(k)}=[1e^{j2πΔfT}^{_{c}}e^{j2πΔf2T}^{_{c}} . . . e^{j2πΔf(N-1)T}^{_{c}}]^{T}e^{j2πΔfkNT}^{_{c}}
where Δf represents the residual frequency shift (Δf=f₀−\hat{f}₀). By applying the characteristic that the normalized frequency shift is much less than one in a MIMO-CDMA system:

$$ɛ = \frac{Δ f}{1 / {NT}_{c}} •1$$

Thereby, the residual frequency-shift vector can approximated as:
z^{(k)}≈identy vector×e^{j2πΔfkNT}^{_{c}}
By using the characteristic described above and combining channels in two consecutive blocks, the channel response will hold the same assumption. The k-th received preamble block signal can be rewritten as:
x^{(k)}=(h_{d}+hₚ)e^{jφ}^{ₖ}+n^{(k)}
where the equivalent composite vector and phase shift of h_{d} and hₚ are:

$${h}_{d} = {\sum }_{l = 1}^{L} ( {α}_{1 , l} + {α}_{2 , l} ) {c}_{d , l}$$

$${h}_{p} = {\sum }_{l = 1}^{L} ( {α}_{1 , l} + {α}_{2 , l} ) {c}_{p , l}$$

$${ϕ}_{k} = 2 π {f}_{Δ} {kNT}_{c}$$

Finally, by applying the orthogonality characteristic, namely, c^{T}_{p,l}c_{d,l}=0, the k-th received preamble block signal of the matched equivalent composite vector of hₚ is:

$${\tilde{x}}^{( k )} = {h}_{p}^{H} {x}^{( k )} • {\sum }_{n = 1}^{N} {\vert {h}_{p , n} \vert}^{2} {ⅇ}^{j {ϕ}_{k}} + {\tilde{n}}^{( k )}$$

At this time, the phase-shift data PSD can be approximated as:
\hat{φ}ₖ=\tilde{x}^{(k)}

Next, perform channel estimation of the input signal INT by the channel estimation unit 215. In the present embodiment, the channel effect of the 2*2MIMO-CDMA apparatus is estimated by applying the preamble-spreading code CS. The mathematical model of the k-th received preamble block signal is:

$${y}^{( k )} = {\sum }_{l = 1}^{L} {α}_{1 , l}^{( k )} {c}_{s , 1 , l} {s}_{1}^{( k )} + {\sum }_{l = 1}^{L} {α}_{2 , l}^{( k )} {c}_{s , 2 , l} {s}_{2}^{( k )} + {n}^{( k )}$$

where sᵢ^{(k)} represents the k-th preamble symbol of the i-th antenna. For simplicity, we set all of the preamble symbols are equal to one. In addition, c_{S,i,l} represents the temporal signature vector of the i-th antenna after the (l−1)-th delay as shown below:

$$\begin{matrix}{c}_{s , i , 1} = {[ {c}_{s , i} ( 0 ) {c}_{s , i} ( 1 ) ⋯ {c}_{s , i} ( N - 1 ) ]}^{T} \\ {c}_{s , i , 2} = {[ {c}_{s , i} ( N - 1 ) {c}_{s , i} ( 0 ) ⋯ {c}_{s , i} ( N - 2 ) ]}^{T} \\ ⋮ \\ {c}_{s , i , l} = {[ {c}_{s , i} ( N - ( l - 1 ) ) ⋯ {c}_{s , i} ( N - 1 ) {c}_{s , i} ( 0 ) ⋯ {c}_{s , i} ( N - l ) ]}^{T}\end{matrix}$$

where orthogonality holds between two temporal signature vectors transmitted by two different antennas, namely, c_{s,1,1}^{T}C_{s,2,l}=0.

Similarly, it is further assumed that channel response will remain the same for two consecutive blocks. Then, the orthogonality characteristic of the preamble-spreading code can be used to perform despreading process. The channel-estimation value CEV of the l-th path transmitted by the i-th antenna is given as follows:
\hat{α}_{i,l}=c_{s,i,l}^{T}y^{(k)}=α_{i,l}+ñ^{(k)}

To sum up, the estimation unit 200 can estimate to the input signal INT in terms of the preamble-spreading code CS and the pilot-spreading code CP to give the frequency-shift data FSD, the packet timing PT, the phase-shift data PSD, and the channel-estimation value CEV. Moreover, after the frequency-shift data FSD and the packet timing PT are given, the cyclic prefix of the input signal INT is eliminated to give an output signal OUT.

After describing the circuit operation of the estimation unit 200, in the following, the operation method of the whole circuit of the receiver side of the 2*2MIMO-CDMA according to the present invention will be described. Please refer to FIG. 3. As shown in the circuit structure of FIG. 3, the receiver side of the 2*2MIMO-CDMA includes two receiving antennas 301, 305, two estimation units 310, 320, a despreading unit 330, a diversion-decoding unit 340, and a demodulation unit 350. The receiving antennas 301, 305 receive signals via different paths, respectively. The received signals are converted to an input signal of the first path INT1 and an input signal of the second path INT2 and then are transmitted to the estimation unit 310, 320. The estimation units 310, 320, as the circuit operation method of the estimation unit 200 described above, estimate the input signals INT1, INT2, respectively.

The receiving antenna 301 outputs the input signal of the first path INT1 to the estimation unit 310. The estimation unit 310 receives the input signal of the first path INT1 via the RF receiver 212. In terms of an ADC 213, the input signal of the first path INT1 is transmitted to a time-synchronization and frequency-estimation unit 214, a channel estimation unit 215, and a cyclic-prefix removal unit 216. The time-synchronization and frequency-estimation unit 214 estimates the frequency-shift data FSD1 and the packet timing PT of the input signal of the first path INT1 according to a first and a second preamble-spreading code CS1, CS2, and outputs to the cyclic-prefix removal unit 216. Based on this, after verifying the input signal of the first path INT1, the cyclic-prefix removal unit 216 removes the cyclic prefix of the input signal of the first path INT1, and generates a first path output signal OUT1. The channel estimation unit 215, likewise, performs channel estimation to the input signal of the first path INT1 according to the first and the second preamble-spreading code CS1, CS2, and outputs to a first path channel-estimation value CEV1. The phase estimation unit 217 estimates the phase-shift data of the first path PSD1 according to the pilot-spreading code CP and the first path output signal OUT1.

The receiving antenna 305 outputs the input signal of the second path INT2 to the estimation unit 320. The method of circuit operation of the estimation unit 320 is similar to that of the estimation unit 310. The main difference is that the time-synchronization and frequency-shift unit 214 and the channel estimation unit 215 of the estimation unit 320 is used to estimate a first and a second preamble-spreading code CS1, CS2 of the frequency-shift data of the second path FSD2. The estimation unit 320 then uses the first and the second preamble-spreading code CS1, CS2, the pilot-spreading code CP to output a channel-estimation value CEV2 of the second path, phase-shift data of the second path PSD2, and an output signal OUT2.

A despreading unit 330 detects the output signals of the estimation units 310, 320 by using data-spreading code CD. The despreading unit 330 receives the phase-shift data of the first path PSD1, the output signal of the first path OUT1, and the channel-estimation value of the first path CEV1 to detect data of the input signal of the first path INT1, and receives the phase-shift data of the second path PSD2, the output signal of the second path OUT2, and the channel-estimation value of the second path CEV2 to detect data of the input signal of the second path INT2. Then, the method of Maximum Ratio Combiner (MRC) is used to get the coherently combined received signal of the input signal of the first path INT1 and the input signal of the second path INT2, and to output despreading data DSD. Afterwards, by using the diversion-coding unit 340 and the demodulation unit 350 to recover the original data DA transmitted by the transmitter side of the 2*2MIMO-CDMA.

The method that the despreading unit 330 uses to detect data can be verified mathematically as follows:

Let the transmission environment is a frequency-selective channel, and the channel can be expressed by using discrete-time pulse response of length L as shown below:
gᵢ=[α_{i,0}α_{i,1} . . . α_{i,L-1}]^{T}, i=1, 2
where i represents the i-th antenna, and the l-th channel α_{i,1} has the fading characteristics of Rayleigh distribution. In addition, by taking a 2-input 1-output MIMO-CDMA (namely, 2*1MIMO-CDMA) apparatus for example, the receiving mathematical model can be expressed as:

$$\begin{matrix}{y}^{( j )} = {[ {y}^{( j )} ( 0 ) , {y}^{( j )} ( 1 ) , … , {y}^{( j )} ( N - 1 ) ]}^{T} for j = k , k + 1 \\ = {\sum }_{l = 1}^{L} {α}_{1 , l}^{( j )} ( {c}_{d , l} {d}_{1}^{( j )} + {c}_{p , l} {p}_{1}^{( j )} ) + {\sum }_{l = 1}^{L} {α}_{2 , l}^{( j )} ( {c}_{d , l} {d}_{2}^{( j )} + {c}_{p , l} {p}_{2}^{( j )} ) + {n}^{( j )}\end{matrix}$$

where j represents the j-th symbol block (two blocks in total, namely, k and k+1), α_{i,1}^{(j)} represents the channel response of the j-th block, dᵢ^{(j)} represents the j-th transmitted symbol data from the i-th antenna, and c_{d,l} represents the temporal signature vector after the (l−1)-th delay as shown below:

$$\begin{matrix}{c}_{d , 1} = {[ {c}_{d} ( 0 ) {c}_{d} ( 1 ) ⋯ {c}_{d} ( N - 1 ) ]}^{T} \\ {c}_{d , 2} = {[ {c}_{d} ( N - 1 ) {c}_{d} ( 0 ) ⋯ {c}_{d} ( N - 2 ) ]}^{T} \\ ⋮ \\ {c}_{d , l} = {[ {c}_{d} ( N - ( l - 1 ) ) ⋯ {c}_{d} ( N - 1 ) {c}_{d} ( 0 ) ⋯ {c}_{d} ( N - l ) ]}^{T}\end{matrix}$$

Because transmitted data adopts STBC technology, the transmitted symbol can be expressed as:
d₁^{(k)}=d₁^{(k)},d₂^{(k)}=d₂^{(k)}
d₁^{(k+1)}=d₂^{(k)}*,d₂^{(k+1)}=d₁^{(k)}*
Next, in order to detect data the despreading technology will be adopted, wherein different paths will use different despreading code c_{d,l} as below:
\tilde{y}ₗ^{(k)}=c_{d,1}^{T}y^{(k)}=α_{1,l}^{(k)}d₁^{(k)}+α_{2,l}^{(k)}d₂^{(k)}+ñₗ^{(k)} for l=1, . . . , L
\tilde{y}ₗ^{(k+1)}=c_{d,1}^{T}y^{(k+1)}=−α_{1,l}^{(k+1)}d₂^{(k)}*+α_{2,l}^{(k+1)}d₁^{(k)}*+ñₗ^{(k+1)}
If the application environment of the system is an indoor environment, the change rate of the environment channel is very slow. Thereby, it can be further assumed that in two consecutive blocks, channel responses will remain the same, and can be expressed as below:
α_{1,l}^{(k+1)}=α_{1,l}^{(k)}=α_{1,l}
α_{2,l}^{(k+1)}=α_{2,l}^{(k)}=α_{2,l}
Here, the despreading data of the k-th and the (k+1)-th block can expressed by vectors as below:

$${\tilde{y}}_{l}^{( k )} = [ \begin{matrix}{\tilde{y}}_{l}^{( k )} \\ {\tilde{y}}_{l}^{{( k + 1 )}^{*}}\end{matrix} ] = [ \begin{matrix}{α}_{1 , l} & {α}_{2 , l} \\ {α}_{2 , l}^{*} & - {α}_{1 , l}^{*}\end{matrix} ] [ \begin{matrix}{d}_{1}^{( k )} \\ {d}_{2}^{( k )}\end{matrix} ] + {\tilde{n}}_{l}^{( k )}$$

In order to get the optimum gain, the MRC method will be applied with the channel-estimation value CEV to get coherently combined received signals of L paths.

In the present embodiment, L=2:

$$\begin{matrix}{\overline{y}}^{( k )} = {\sum }_{l = 1}^{L} {[ \begin{matrix}{α}_{1 , l} & {α}_{2 , l} \\ {α}_{2 , l}^{*} & - {α}_{1 , l}^{*}\end{matrix} ]}^{H} \\ {\tilde{y}}_{l}^{( k )} = {\sum }_{l = 1}^{L} ( {\vert {α}_{1 , l} \vert}^{2} + {\vert {α}_{2 , l} \vert}^{2} ) [ \begin{matrix}{d}_{1}^{( k )} \\ {d}_{2}^{( k )}\end{matrix} ] + {\overline{n}}_{l}^{( k )} where {\overline{y}}^{( k )} • [ \begin{matrix}{\overline{y}}_{1}^{( k )} \\ {\overline{y}}_{2}^{( k )}\end{matrix} ]\end{matrix}$$

The above equation is the despreading data DSD of a 2-input 1-output MIMO-CDMA (namely, 2*1MIMO-CDMA) apparatus. Similarly, by using the method of MRC, it is easy to expand to a 2-input 2-output MIMO-CDMA (namely, 2*2MIMO-CDMA) apparatus. We can get diversity gain of space and path at the same time. The present embodiment is a 2*2MIMO-CDMA apparatus. After the disclosure of the present invention, the persons skilled in the art should be able to induce easily the structure and method of circuit operation of a MIMO-CDMA. It will not be described further.

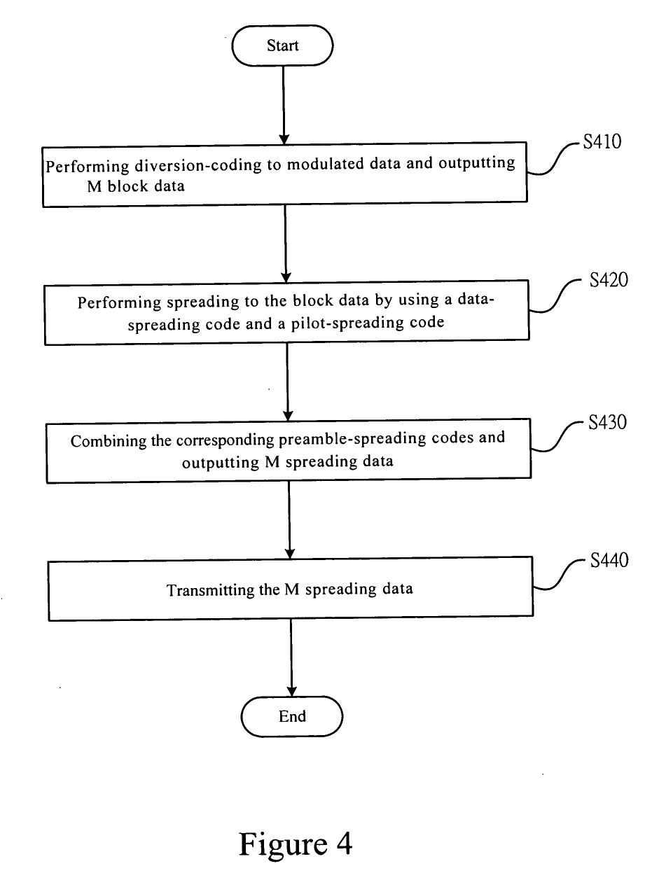

FIG. 4 is a coding method of a MIMO-CDMA apparatus according to an embodiment of the present invention. The MIMO-CDMA apparatus includes M transmitting antennas and K receiving antennas, where M and K are natural numbers. The coding method includes the following steps: First, in the step S410, perform diversion-coding to modulated data and output M block data. The diversion coding method includes STBC algorithm (in another embodiment of the present invention is the space-multiplexing algorithm). In the step S420, perform spreading to M block data, respectively, by using the data-spreading code CD and the pilot-spreading code CP. In the step S430, by using the timing-switching method, combine the corresponding preamble-spreading code CS to form a complete frame format, and output M spreading data. Then, in the step S440, transmit the M spreading data using RF carriers.

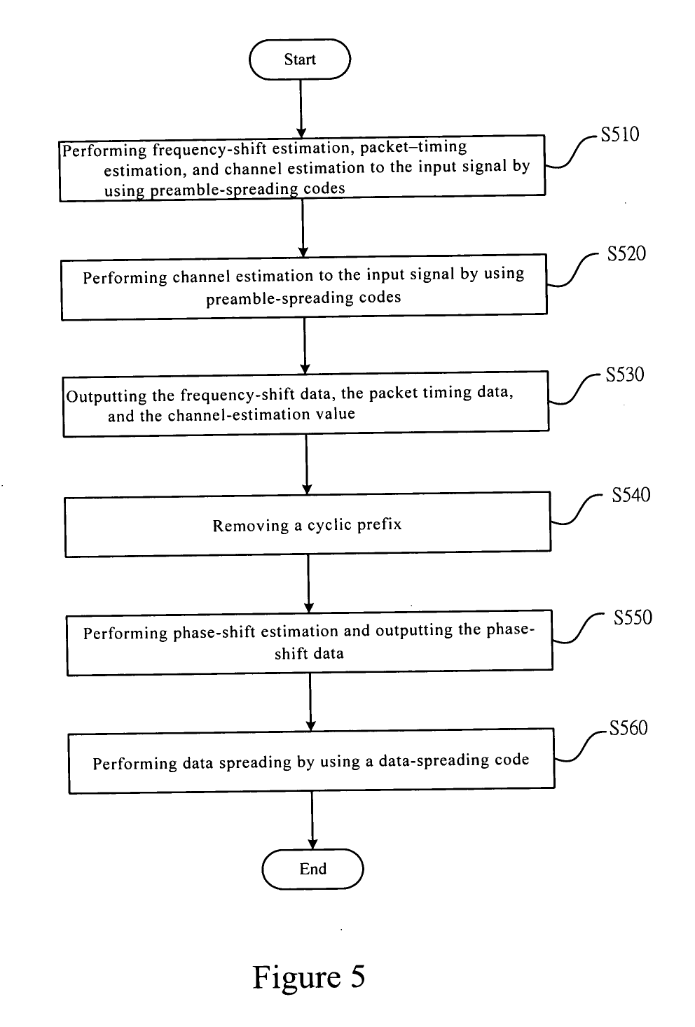

FIG. 5 is a decoding method of a MIMO-CDMA apparatus according to an embodiment of the present invention. The MIMO-CDMA apparatus includes M transmitting antennas and K receiving antennas, where M and K are natural numbers. Before the beginning of the steps, use the K receiving antennas to receive, respectively, signals transmitted via different paths, and output K input signals INT. The decoding method includes the following steps: In the step S510, by using the preamble-spreading code CS, perform frequency-shift estimation, packet timing estimation, and channel estimation to the input signal. Then, in the step S520, perform channels estimation to the input signal INT by using the preamble-spreading code CS. The execution order of the step S510 and the step S520 can be swapped in another embodiment. To further explain, the main accomplished task in the step S510 and the step S520 is to perform frequency-shift estimation and channels estimation to the input signal received by the i-th receiving antenna by using the preamble-spreading code CS. In the step S530, output the corresponding i-th frequency-shift data FSD, the i-th packet timing PT, and the i-th channel-estimation value CEV, where i is a natural number, and 0<i□K.

Next, in the step S540, according to the i-th frequency-shift data FSD and the i-th packet timing PT, remove the cyclic prefix of the i-th input signal INT.

In the step S550, use a pilot-spreading code CP to perform phase estimation to the i-th input signal after removal of the cyclic prefix, and output the corresponding i-th phase-shift data PSD. Afterwards, in the step S560, use a data-spreading code CD, the i-th phase-shift data PSD, and the i-th channel-estimation value to perform data spreading to the i-th input signal after removal of the cyclic prefix, and produce the i-th sub-despreading data. Then, combine the first to the K-th sub-despreading data, and output despreading data DSD. After getting the despreading data DSD, use the method of diversion coding to recover the original data of the input data INT.

The data-spreading code and the pilot-spreading code describe above are orthogonal in the present embodiment. Any two preamble-spreading codes CS (for example, the first preamble-spreading code CS1 and the second preamble-spreading code CS2) are orthogonal as well.

The details of the coding and decoding methods in the embodiment of FIG. 4 and FIG. 4 as described above have been disclosed in the description. The persons skilled in the art can implement the coding and decoding methods with ease. Thereby, more details of the coding and decoding methods will not be addressed further.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A Multiple-Output Multiple-Input Code-Division Multiple Access (MIMO-CDMA) apparatus, comprising:
a coding unit, used to code data;
a modulation unit, coupling to the coding unit and used to modulate the output of the coding unit;
a diversion-coding unit, coupling to the modulation unit and used to code the output signals of the modulation unit as well as to output M block data;
a spreading unit, coupling to the diversion-coding unit, and, by using a data-spreading code, a pilot-spreading code, and a plurality of preamble-spreading codes, performing spreading coding and then outputting M spreading data;
M radio-frequency (RF) transmitting modules, coupling to the spreading unit, respectively, and receiving one of the spreading data, respectively;
M transmitting antennas, coupling to the RF transmitting modules, respectively, the RF transmitting modules using the transmitting antennas to transmit one of the spreading data, respectively;
K receiving antennas;
K estimation units, coupling to the receiving antennas, respectively, and performing channel estimation, packet timing estimation, and frequency offset estimation to the signals received by the receiving antennas using the preamble-spreading codes, and performing phase estimation to the signals received by the receiving antennas using the pilot-spreading code;
a despreading unit, coupling to the estimation units, and, by using the data-spreading code, performing data despreading to the output of the estimation units and outputting despreading data;
a diversion-decoding unit, coupling to the despreading unit, and performing diversion decoding to the despreading data;
a demodulation unit, coupling to the diversion-decoding unit, and demodulating the output of the diversion-decoding unit; and
a decoding unit, coupling to the demodulation unit, and decoding the output of the demodulation unit;
wherein M and K are natural numbers, and the signals received by the receiving antennas corresponding to the spreading signals transmitted by the transmitting antennas, the estimation units and the receiving antennas having a one-to-one correspondence.

2. The MIMO-CDMA apparatus of claim 1, wherein the methods of modulating the output of the coding unit by the modulation unit include Quadrature Phase-Shift Keying (QPSK).

3. The MIMO-CDMA apparatus of claim 1, wherein the methods of coding the output of the modulatio unit by the diversion-coding unit include space-time block coding algorithm.

4. The MIMO-CDMA apparatus of claim 1, wherein the methods of coding the output of the modulatio unit by the diversion-coding unit include space-multiplexing algorithm.

5. The MIMO-CDMA apparatus of claim 1, wherein the spreading unit comprises:
M multiplexers, coupling to the RF transmitting modules, respectively;
M data-spreading units, coupling between one of the multiplexers and the diversion-coding unit, and performing spreading coding to every block datum by using the data-spreading code and the pilot-spreading code; and
a preamble-spreading unit, coupling to the multiplexers, and transmitting the plurality of preamble-spreading codes to the multiplexers, each multiplexer corresponding to one of the plurality of preamble-spreading codes;
wherein the multiplexers output one of the spreading data to one of the corresponding RF transmitting modules, respectively, according to outputs of the data pilot-spreading units and the corresponding preamble-spreading codes.

6. The MIMO-CDMA apparatus of claim 5, wherein one of the corresponding RF transmitting modules comprises:
a RF transmitter, coupling to one of the transmitting antennas; and
a digital-to-analog converter (DAC), coupling to the RF transmitter and to one of the multiplexers.

7. The MIMO-CDMA apparatus of claim 1, wherein the data-spreading code and the pilot-spreading code are orthogonal.

8. The MIMO-CDMA apparatus of claim 1, wherein one of the plurality of the preamble-spreading codes and one of the rest of the plurality of the preamble-spreading codes are orthogonal.

9. The MIMO-CDMA apparatus of claim 1, wherein the modulation unit includes adding a cyclic prefix to the output signal of the modulation unit.

10. The MIMO-CDMA apparatus of claim 1, wherein one of the estimation units includes:
a RF receiving module, coupling to one of the corresponding receiving antennas, and outputting a received signal by using the signals received by one of the receiving antennas;
a time-synchronization and frequency-shift estimation unit, coupling to the RF receiving module, and outputting a packet timing and frequency-shift data of the received signal;
a cyclic-prefix removal unit, coupling between the despreading unit and the RF receiving module, and removing a cyclic prefix from the received signal according to the packet timing and frequency-shift data;
a channel estimation unit, coupling between the RF receiving unit and the despreading unit, and estimating the channel effects of the received signal according to the preamble-spreading code, and outputting a channel-estimation value to the despreading unit; and
a phase estimation unit, coupling between the despreading unit and the cyclic-prefix removal unit, and outputting phase-shift data to the despreading unit according to the pilot-spreading code.

11. The MIMO-CDMA apparatus of claim 10, wherein the despreading unit performs data despreading to the output of the cyclic-prefix removal unit according to the data-spreading code, the phase-shift data, and the channel-estimation value.

12. The MIMO-CDMA apparatus of claim 10, wherein the RF receiving module comprises:
a RF receiver, coupling to one of the receiving antennas; and
an analog-to-digital converter (ADC), coupling to the RF receiver and outputting the receive signal.

13. The MIMO-CDMA apparatus of claim 1, wherein the diversion-decoding unit includes coding the output of the modulation unit by applying a space-time block decoding algorithm.

14. A coding method of a Multiple-Output Multiple-Input Code-Division Multiple Access (MIMO-CDMA) apparatus, the MIMO-CDMA apparatus including M transmitting antennas and K receiving antennas, where M and K are natural numbers, the coding method comprising the steps of:
performing diversion-coding to modulated data, and outputting M block data;
performing spreading to the block data, by using a data-spreading code, a pilot-spreading code, and a plurality of preamble-spreading codes, and outputting M spreading data; and
transmitting the spreading data using the transmitting antennas, respectively, the spreading data and the transmitting antennas having a one-to-one correspondence.

15. The coding method of a MIMO-CDMA apparatus of claim 14, wherein before the step of performing diversion-coding to modulated data and outputting M block data, further comprising the steps of:
coding data; and
modulating the coded data, and adding a cyclic prefix.

16. The coding method of a MIMO-CDMA apparatus of claim 14, wherein the step of performing diversion-coding to modulated data, the algorithm used to code the modulated data includes a space-time block coding algorithm.

17. The coding method of a MIMO-CDMA apparatus of claim 14, wherein the step of performing diversion-coding to modulated data, the algorithm used to code the modulated data includes a space-multiplexing algorithm.

18. The coding method of a MIMO-CDMA apparatus of claim 14, wherein the data-spreading code and the pilot-spreading code are orthogonal.

19. The coding method of a MIMO-CDMA apparatus of claim 14, wherein one of the plurality of the preamble-spreading codes and one of the rest of the plurality of the preamble-spreading codes are orthogonal.

20. A decoding method of a MIMO-CDMA apparatus, the MIMO-CDMA apparatus including M transmitting antennas and K receiving antennas, wherein M and K are natural numbers, the coding method comprising the steps of:
performing frequency-shift estimation and channel estimation to the input signal received by the i-th receiving antenna by using a plurality of preamble-spreading codes, and outputting the corresponding i-th frequency-shift data, the i-th packet timing PT, and the i-th channel-estimation value, i being a natural number, and 0<i□K.
removing a cyclic prefix of the i-th input signal, according to the i-th frequency-shift data and the i-th packet timing;
performing phase estimation to the i-th input signal after removal of the cyclic prefix by using a pilot-spreading code, and outputting the corresponding i-th phase-shift data;
performing data spreading to the i-th input signal after removal of the cyclic prefix by using a data-spreading code, the i-th phase-shift data, and the i-th channel-estimation value, and producing the i-th sub-despreading data;
outputting despreading data, according to the first to the K-th sub-despreading data; and
performing diversion decoding to the despreading data.

21. The decoding method of a MIMO-CDMA apparatus of claim 20, wherein the step of performing diversion decoding to the despreading data, the algorithm used to perform diversion decoding to the despreading data includes a space-time block coding algorithm.

22. The decoding method of a MIMO-CDMA apparatus of claim 20, wherein the data-spreading code and the pilot-spreading code are orthogonal.

23. The decoding method of a MIMO-CDMA apparatus of claim 20, wherein one of the plurality of the preamble-spreading codes and one of the rest of the plurality of the preamble-spreading codes are orthogonal.
